(19) United States
(12) Patent Application Publication
(10) Pub. No.: US 2008/0023653 A1
(43) Pub. Date: Jan. 31, 2008

(54) Plasma based ion implantation apparatus

(75) Inventors: Young dong Lee, Suwon-si (KR); Yuri Tolmachev, Suwon-si (KR); Vladimir Volynets, Suwon-si (KR); Vasily Pashkovskiy, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/603,100

(22) Filed: Nov. 22, 2006

(30) Foreign Application Priority Data
Jul. 25, 2006 (KR) 2006-70037

(51) Int. Cl. G21K 5/08

(52) U.S. Cl. 250/492.21

(57) ABSTRACT

A plasma based ion implantation apparatus. The apparatus includes a first chamber in which plasma is generated, a coil antenna to generate the plasma in the first chamber, a second chamber in which ions of the plasma are implanted into a target, the second chamber having an incoming port through which the plasma is diffused from the first chamber to the second chamber, a power source to supply high voltage power to the target in the second chamber, and a grounded conductor positioned to face the target seated on the seating table. The first chamber is formed with a ring shape opening of a predetermined width at an upper periphery of the second chamber to communicate with the second chamber.

### CROSS-REFERENCE TO RELATED APPLICATIONS

This application claims priority under 35 U.S.C. §119(a) from Korean Patent Application No. 2006-0070037, filed on Jul. 25, 2006 in the Korean Intellectual Property Office, the disclosure of which is incorporated herein in its entirety by reference.

### BACKGROUND OF THE INVENTION

1. Field of the Invention

The present general inventive concept relates to an ion implantation apparatus, and more particularly to a plasma based ion implantation apparatus.

2. Description of the Related Art

Ion implantation is a materials engineering process by which impurity atoms with a high kinetic energy are implanted into a wafer surface through an ionization and acceleration of impurities desired to be implanted into the wafer.

In semiconductor device fabrication, an ion implantation process serves to create characteristics of electronic elements by accelerating and implanting ionized impurities into a portion of the wafer connected to a circuit pattern. In the semiconductor device fabrication, the ion implantation process is generally performed by use of a conventional ion implantation apparatus employing ion beams, i.e., a conventional ion beam based ion implantation apparatus.

The conventional ion beam based ion implantation apparatus generally includes an ion source, an accelerator, and a high vacuum device. Thus, the conventional ion beam based ion implantation apparatus suffers from problems of a complicated structure, a large volume, and a high price causing high manufacturing costs.

Recently, semiconductor devices have been developed to have a high degree of integration, which is accompanied with a decrease in line width. Accordingly, it has been required to have a shallow junction depth so as to correspond with the decrease in line width, and to implant a greater amount of ions so as to improve an operating speed of the semiconductor device. In order to make the junction depth thinner, it is necessary to employ ions having a low energy. However, the conventional ion beam based ion implantation apparatus has a problem in that, as the energy of the ions decreases, a divergence of the ion beams caused by repulsion between the ions becomes significant, causing a reduction of ion implantation efficiency. In other words, in order to satisfy requirements for the ion implantation process to manufacture highly integrated semiconductor devices, the conventional ion beam based ion implantation apparatus suffers from problems in that process efficiency and productivity are significantly reduced.

In order to overcome the problems of the conventional ion beam based ion implantation technique, a plasma based ion implantation technique has been developed.

According to the plasma based ion implantation technique, a plasma is formed from an implantation object material, which is introduced in a gas state into a reaction chamber, and positive ions of the plasma are then collided with and implanted into a surface of a target by application of high voltage pulses to the target.

Due to the high voltage pulses applied to the target, a plasma sheath is created around the target, and ions enter the surface of the target in a perpendicular direction to a border of the plasma sheath. At this point, when entering the surface of the target, the ions infiltrate the target with a high kinetic energy, thereby accomplishing ion implantation.

Unlike the conventional ion beam based ion implantation process, the plasma based ion implantation is not a linear processing technique, and thus a uniform ion implantation layer on the surface of the target can be formed by controlling only a size of the plasma sheath without stepping or rotating the target, thereby accomplishing a remarkable increase in processing rate. In addition, the plasma based ion implantation apparatus has advantages in view of its simple structure, small volume, and low price.

FIG. 1 is a cross-section illustrating one example of a conventional plasma based ion implantation apparatus.

Referring to FIG. 1, the conventional plasma based ion implantation apparatus includes a cylindrical reaction chamber 1 having a plasma generating space, a table 2 positioned at a lower portion of the reaction chamber 1 to support a substrate, such as a wafer W, a dielectric window 4 on an upper cover 3 of the reaction chamber 1, a coil antenna 5 positioned on the dielectric window 4 while being connected with an RF power supply (not illustrated) to generate plasma within the reaction chamber 1, and a high voltage power supply 6 on a rear side of the table 2 to apply a high voltage pulse to the wafer W in order to precisely control an energy of ions implanted into the wafer W mounted on the table 2.

The reaction chamber 1 has a gas injection port la formed at a side wall thereof through which a reaction gas is injected into the reaction chamber 1, and a vacuum suction port 1b at a bottom surface thereof to which a vacuum pump 7 is connected such that the vacuum chamber 1 is evacuated through the vacuum suction port 1b by the vacuum pump 7.

In the conventional plasma based ion implantation apparatus, when a magnetic field is generated by an RF current passing through the coil antenna 5, an electric field is induced in the reaction chamber 1 by virtue of a change of a magnetic field according to a time. Simultaneously, the reaction gas is introduced into the reaction chamber 1 through the gas injection port la, and ionized through collision between electrons which are accelerated by the induced electric field therein, thereby generating plasma in the reaction chamber 1.

Then, ions of the plasma enter a surface of the wafer W by means of the high voltage pulse applied to the wafer W. When entering the surface of the target, the ions infiltrate the wafer W with a high kinetic energy, thereby accomplishing ion implantation.

At this point, the ions of the plasma are strongly accelerated by the high voltage pulse applied to the wafer, and generate a large number of secondary electrons when colliding with an inner wall of the reaction chamber 1 and the wafer W. The secondary electrons are accelerated in the plasma sheath which is formed around the wafer W and has a strong electric field, and electrically charge the dielectric window 4 on the reaction chamber 1 such that the dielectric window 4 has a high negative potential. Generally, in the conventional plasma based ion implantation apparatus, a potential of the dielectric window 4 charged by a high voltage pulse of about 5 kV becomes about 1˜2 kV.

The dielectric window 4 having such a high negative potential strongly attracts the ions of the plasma distributed around the dielectric window 4 to cause sputtering of the dielectric window 4 so that by-products resulting from the sputtering contaminate the surface of the wafer W and the inner wall of the reaction chamber 1.

In addition, since the reaction chamber 1 of the conventional plasma based ion implantation apparatus has a simple cylindrical structure, an RF electric field is created in the reaction chamber 1 by the RF current flowing through the coil antenna 5, causing arcing in the reaction chamber 1.

Furthermore, when generating plasma by use of the RF power supply, high-density plasma having a high electron temperature is generated. The plasma having the high electron temperature promotes generation of relatively light ions (by activating dissociation of injected gas), and when such relatively light ions are implanted into the surface of the wafer, these ions infiltrate deeply into the wafer, causing a deep junction-depth. Thus, plasma having a high electron temperature is not appropriate for the ion implantation of a highly integrated semiconductor device which requires a shallow junction-depth. Additionally, the conventional plasma based ion implantation apparatus has a problem in that when ions of the high-density plasma having the high electron temperature collide directly with the wafer, the wafer can be damaged.

### SUMMARY OF THE INVENTION

The present general inventive concept provides a plasma based ion implantation apparatus which can prevent contamination of a wafer due to secondary electrons.

The present general inventive concept also provides a plasma based ion implantation apparatus which can reduce arcing by an RF electric field in a reaction chamber.

The present general inventive concept also provides a plasma based ion implantation apparatus which can generate plasma stably under wide pressure conditions, in which plasma is suitable for implantation of many ions into a wafer while ensuring a shallow junction-depth.

Additional aspects and/or advantages of the general inventive concept will be set forth in part in the description which follows and, in part, will be obvious from the description, or may be learned by practice of the general inventive concept.

The foregoing and other aspects and utilities of the present general inventive concept are achieved by providing an ion implantation apparatus, including a plasma generation unit, an ion implantation unit to implant ions of plasma generated in the plasma generation unit into a target, and a grounded conductor disposed in the ion implantation unit to prevent electric charging.

The plasma generation unit may include a first chamber to define a space to generate the plasma, a coil antenna positioned at one side of the first chamber to generate the plasma, and a power supply to supply power to the coil antenna.

The ion implantation unit may include a second chamber to define an ion implantation space in which the ions of the plasma generated in the plasma generation unit are implanted into the target, and a power source to supply a high voltage power to the target in the second chamber.

The power supply may supply RF power.

The power source may apply a high voltage pulse to the target.

The first chamber may be formed with a ring shape of a predetermined height at an upper periphery of the second chamber.

The second chamber may have a cylindrical shape.

The first chamber and the second chamber may be formed of an insulating material.

The second chamber may be formed with an incoming port corresponding to a lower side of the first chamber to allow the plasma to be diffused from the first chamber to the second chamber.

The ion implantation unit may include a table on which the target is mounted, and the conductor may be positioned to face the table.

The conductor may include Si.

The first chamber may include a first gas injection port, and the second chamber may include a second gas injection port.

The foregoing and/or other aspects and utilities of the present general inventive concept are also achieved by providing a plasma based ion implantation apparatus, including a first chamber in which plasma is generated, a second chamber in which ions of the plasma are implanted into a target, the second chamber having an incoming port through which the plasma is diffused from the first chamber to the second chamber, a coil antenna to generate the plasma in the first chamber, and a power source to supply a high voltage power to the target in the second chamber.

The coil antenna may be supplied with RF power, and the power source may apply a high voltage pulse to the target.

The first chamber may be formed with a ring shape of a predetermined height at an upper periphery of the second chamber, and the second chamber may have a cylindrical shape.

The incoming port may have a ring shape to open a lower side of the first chamber to the second chamber.

The second chamber may include a grounded conductor to prevent electric charging, and the conductor may be formed of Si.

The second chamber may include a table on which the target is mounted, and the conductor may be positioned to face the target mounted on the table.

The first chamber may include a first gas injection port, and the second chamber may include a second gas injection port.

The foregoing and/or other aspects and utilities of the present general inventive concept are also achieved by providing a plasma based ion implantation apparatus, including a first chamber in which plasma is generated, a coil antenna to generate the plasma in the first chamber, a second chamber in which ions of the plasma are implanted into a target mounted on a table disposed inside the second chamber, the second chamber having an incoming port through which the plasma is diffused from the first chamber to the second chamber, a power source to supply a high voltage power to the target in the second chamber, and a grounded conductor positioned to face the target.

The foregoing and/or other aspects and utilities of the present general inventive concept are also achieved by providing a plasma based ion implantation apparatus, including a first ring-shaped chamber in which plasma is generated, a coil antenna to generate the plasma in the first chamber, a second chamber in which ions of plasma diffused from the first chamber to the second chamber are implanted into a target, and a power source to supply a high voltage power to the target in the second chamber, wherein the first chamber is formed with a ring shape opening having a predetermined width at an upper periphery of the second chamber to communicate with the second chamber.

The foregoing and/or other aspects and utilities of the present general inventive concept are also achieved by providing an ion implantation apparatus, including an upper chamber to generate plasma, and a lower chamber to implant ions of the plasma generated in the upper chamber into a target, wherein the upper chamber is disposed on an upper surface of the lower chamber and communicates with the lower chamber to allow the diffusion of the plasma to the lower chamber.

The upper chamber may be configured to prevent an electric field used to generate the plasma from propagating into the lower chamber to suppress arcing in the lower chamber.

The apparatus may further include an antenna coil to generate plasma in the upper chamber, disposed to surround the upper chamber, and a conductor plate disposed inside the lower chamber and above the target to prevent the target from being contaminated.

The apparatus may further include an antenna coil to generate plasma in the upper chamber, disposed at an upper surface of the upper chamber, and a conductor plate disposed inside the lower chamber and above the target to prevent the target from being contaminated.

### BRIEF DESCRIPTION OF THE DRAWINGS

These and/or other aspects and advantages of the present general inventive concept will become apparent and more readily appreciated from the following description of the embodiments, taken in conjunction with the accompanying drawings, of which:

FIG. 1 is a cross-sectional view illustrating one example of a conventional plasma based ion implantation apparatus;

FIG. 2 is a cross-sectional view illustrating a plasma based ion implantation apparatus according to an embodiment of the present general inventive concept;

FIG. 3 is a cut-away perspective view illustrating the plasma based ion implantation apparatus of FIG. 2;

FIG. 4 is a graph illustrating results of measurements for electron temperature along an axis Z-Z′ of FIG. 2;

FIG. 5 is a graph illustrating results of measurements for plasma potential along the axis Z-Z′ of FIG. 2;

FIG. 6 is a graph illustrating results of measurements for plasma density along the axis Z-Z′ of FIG. 2;

FIG. 7 is a computational simulation illustrating plasma density of the plasma based ion implantation apparatus according to the present general inventive concept;

FIG. 8 is a computational simulation illustrating plasma electron temperature of the plasma based ion implantation apparatus according to the present general inventive concept; and

FIG. 9 is a cross-sectional view illustrating a plasma based ion implantation apparatus according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

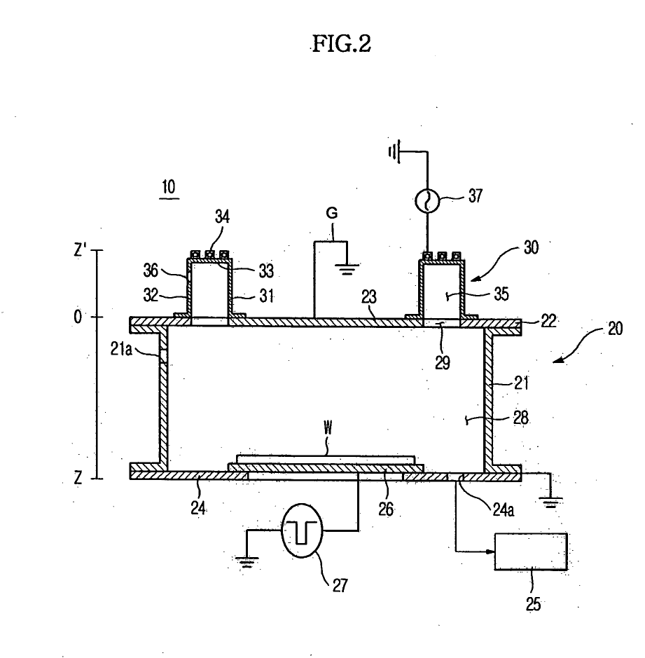

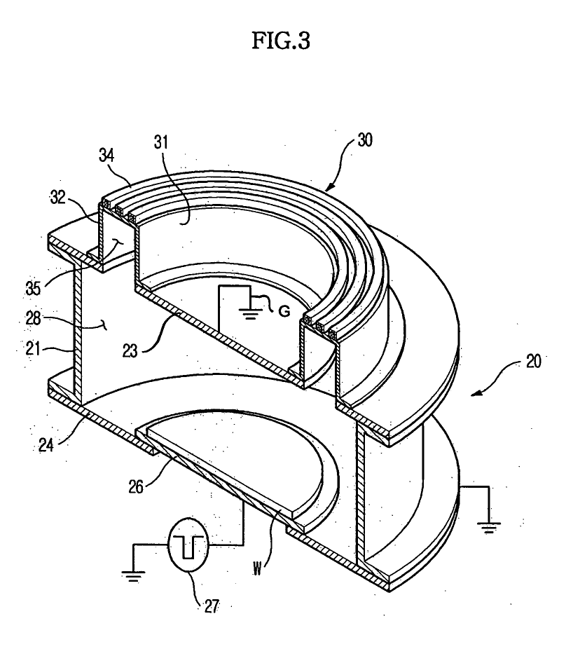

FIG. 2 is a cross-sectional view illustrating a plasma based ion implantation apparatus according to an embodiment of the present general inventive concept, and FIG. 3 is a cut-away perspective view illustrating the plasma based ion implantation apparatus of FIG. 2.

A plasma based ion implantation apparatus refers to a semiconductor manufacturing apparatus which forces positive ions of plasma to collide with and be implanted into a surface of a target, such as a wafer, through application of high voltage pulses to the target after forming the plasma from an implantation object material, which is introduced in a gas state in a reaction chamber.

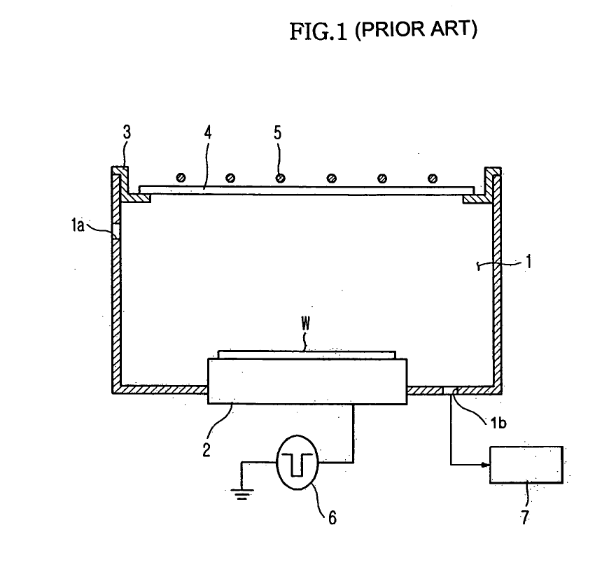

Referring to FIGS. 1 and 2, a plasma based ion implantation apparatus 10 according to an embodiment of the present general inventive concept may include a plasma generation unit 30 to generate plasma, and an ion implantation unit 20 in which an ion implantation process is performed to implant the positive ions of the plasma into a wafer W through diffusion of the plasma generated in the plasma generation unit 30.

The plasma generation unit 30 may include a first chamber 35 to define a space to generate plasma, a coil antenna 34 positioned at an upper portion of the first chamber 35 to induce the plasma in the first chamber 35, and a power supply 37 to supply power to the coil antenna 34.

The first chamber 35 may include an outer insulating body 32 to constitute an outer periphery of a cylindrical body, an inner insulating body 33 to constitute an inner periphery of the cylindrical body, and an insulating plate 33 to cover an upper portion of the cylindrical body between the inner and outer insulating bodies 33 and 32, defining the plasma generation space therein. Hence, the first chamber 35 is formed with a ring-shape having a relatively constant height and open at a lower portion thereof. The first chamber 35 may have a width of about 4 cm and a height of about 7.5 cm.

The first chamber 35 includes a first gas injection port 36 through which a reaction gas is injected into the first chamber 35 which may be formed at one side of the outer insulating body 32 to ensure a smooth electric charging to generate the plasma. Alternatively, the first gas injection port 36 may also be formed through the inner insulating body 33, and may have a variable installation height according to a design used.

The coil antenna 34 may be positioned on the insulating plate 33, and may be formed by turning coils several times in a circular or spiral shape. The coil antenna 34 serves to induce an electric field which is used to generate plasma through ionization of the reaction gas injected into the first chamber 35. The power supply 37 is connected to the coil antenna 34 to supply an RF power to the coil antenna 34. The RF power from the power supply 37 may have a frequency of about 2 MHz. Accordingly, as an RF current flows through respective coils constituting the coil antenna 34, a magnetic field is generated according to Ampere's right-hand rule, followed by an inducement of an electric field in a circumferential direction within the first chamber 35 according to Faraday's Law of Electromagnetic Induction by virtue of a variation of the magnetic field according to a time. The induced electric field accelerates electrons in the reaction gas, which ionize the reaction gas injected into the first chamber 35 through the first gas injection port 36, thereby generating plasma.

Such a first ring-shaped chamber 35 permits generation of plasma at a pressure in a wider range than that of the conventional cylindrical reaction chamber.

The ion implantation unit 20 may include a second chamber 28 to define an ion implantation space where ions of the plasma generated in the plasma generation unit 30 are implanted to the wafer W, and a power source 27 to supply a high voltage power to the wafer W within the second chamber 28.

The second chamber 28 may include a cylindrical main body 21, an upper cover 22 to cover an upper periphery of the main body 21, and a lower cover 24 to cover a lower portion of the main body 21 so as to define the ion implantation space in the second chamber 28.

The interior of the second chamber 28 may be maintained in a vacuum state. To this end, the lower cover 24 of the second chamber 28 may be formed with a vacuum suction port 24a connected to a vacuum pump 25, and the main body 21 may be formed with a second gas injection port 21a through which a process gas for an ion injection process is injected into the second chamber 28.

The second chamber 28 may be provided at a central region of the lower cover 24 with a table 26 to support the wafer W, and at a central region of the upper cover 22 with a disc-shaped conductor 23 which faces the table 26. The conductor 23 is electrically charged by secondary electrons, and sputtered by the ions of the plasma, thereby preventing the wafer and other components from being contaminated by impurities. The conductor 23 may be grounded by a ground G to prevent electric charging thereof, and may include, for example, Si. The conductor 23 has a larger radius than that of the wafer mounted on the table 26 in order to allow the secondary electrons of the wafer to be directed to the conductor 23.

When the conductor 23 is grounded by the ground G, it is possible to prevent the electric charging of the conductor 23 due to the secondary electrons generated from the wafer so that a wall of the chamber or the wafer can be prevented from being contaminated by impurities caused by the sputtering by ions of the conductor 23.

A space between the upper cover 22 and the conductor 23 may define an incoming port 29 corresponding to the opening on the lower side of the first chamber, via which the first chamber 25 communicates with the second chamber 28 to allow the plasma generated in the first chamber 35 to diffuse to the second chamber 28.

In addition, the power source 27 is connected to one side of the table 26 such that a pulse of high voltage can be applied to the wafer mounted on the table 26. The high voltage pulse enables acceleration of positive ions of the plasma, which is generated in the first chamber 25 and diffuses into the second chamber 28 through the incoming port 29, so that the wafer mounted on the table 26 can be implanted with the ions.

With the plasma based ion implantation apparatus 10 according to the present general inventive concept, inductively coupled plasma of high density is generated in the first ring-shaped chamber 35, and then diffuses into the second cylindrical chamber 28 where the ion implantation is performed. Since the incoming port 29 may also have a ring shape corresponding to the ring shape of the first chamber 35, the plasma diffusing into the second chamber 28 can be uniformly distributed on the wafer W. The ions are then accelerated to have high energy by the high voltage pulse applied from the power source 27 to the wafer W, and collide with a surface of the wafer, thereby accomplishing an ion implantation of the ions into the wafer.

According to the present general inventive concept, the plasma generated in the first chamber 35 having a ring-shaped narrow width, and diffusing into the second cylindrical chamber 28, has a discharge characteristic different from that of plasma generated in the conventional cylindrical reaction chamber of a conventional plasma based ion implantation apparatus.

In particular, in a low pressure discharge condition (10 mTorr or less), plasma of the first chamber 35 is clearly distinguished from plasma of the second chamber 28 in terms of main factors, such as an electron temperature (Te), a plasma density (Np), and plasma potential (Vp).

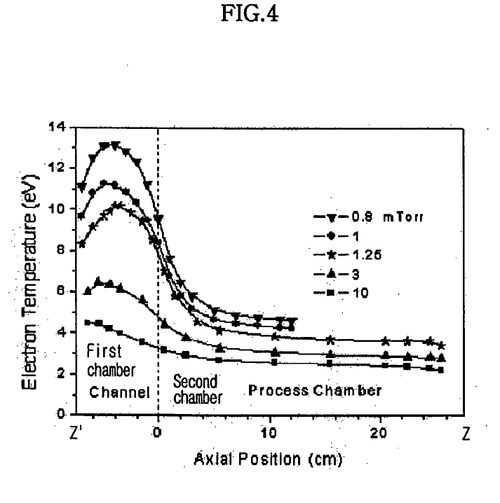

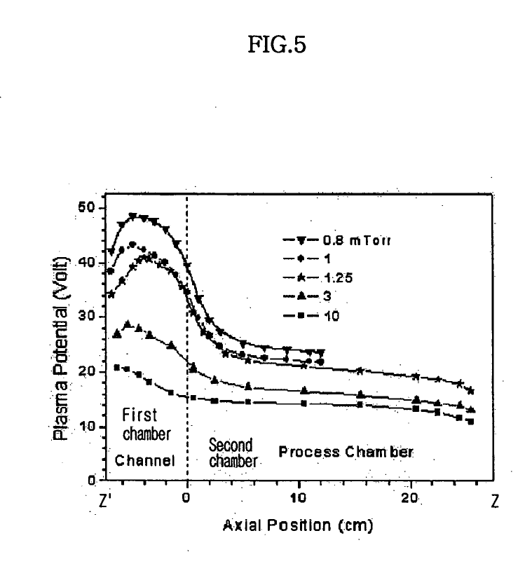

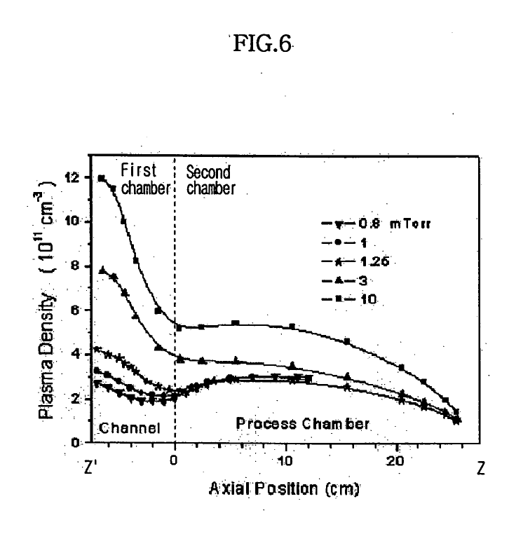

FIG. 4 is a graph illustrating results of measurements for electron temperature along an axis Z-Z′ of FIG. 2, FIG. 5 is a graph illustrating results of measurements for plasma potential along the axis Z-Z′ of FIG. 2, and FIG. 6 is a graph illustrating results of measurements for plasma density along the axis Z-Z′ of FIG. 2.

In FIGS. 4 to 6, results of measurements for main factors of an Argon (Ar) plasma at a pressure range of 0.8˜10 mTorr by use of Langmuir probe are illustrated. As can be seen from FIGS. 4 to 6, plasma generated in the first upper chamber 35 has a high electron temperature of about Te=4˜13 eV, a high plasma potential of about Vp=20˜50 V, and a high plasma density of Np=2˜12 10¹¹ cm³. In particular, at any of the pressure conditions illustrated in FIGS. 4 to 6, the electron temperature and the plasma potential of the plasma in the first upper chamber 35 are always significantly higher than those of the plasma in the second chamber 28 and gradually lower from the first chamber 35 to the second chamber 28.

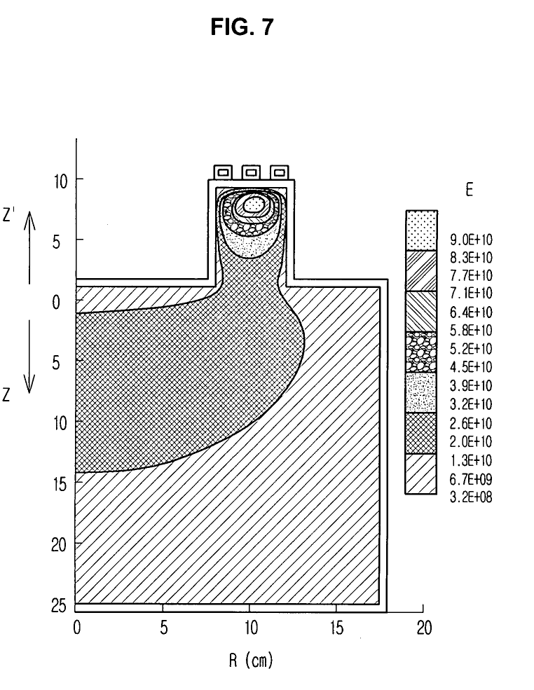

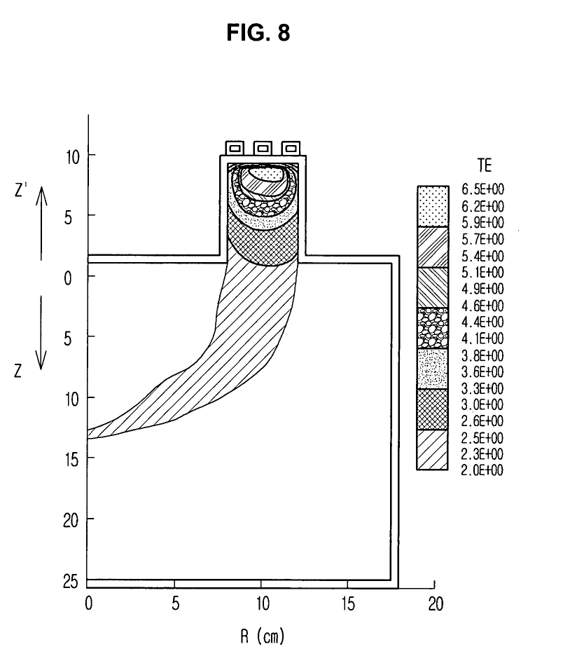

FIG. 7 is a computational simulation illustrating plasma density of the plasma based ion implantation apparatus according to the present general inventive concept, and FIG. 8 is a computational simulation illustrating plasma electron temperature of the plasma based ion implantation apparatus according to the present general inventive concept.

In FIGS. 7 and 8, results of a discharge simulation at a pressure of 3 mTorr using Ar gas are illustrated. From FIGS. 7 and 8, it can be seen that distributions of the plasma density and the plasma electron temperature of plasma are similar to the results illustrated in FIGS. 4 to 6.

As can be understood from FIGS. 4 to 8, although plasma having a high density and a very high electron temperature is generated in the first upper chamber 35, the plasma properties change while diffusing into the second lower chamber 28 so that plasma having a low electron temperature and a suitable density is uniformly distributed in the second chamber 28. The plasma having the low electron temperature appropriately causes dissociation and ionization of a process gas (for example, BF3), thereby further activating a generation of heavier ions (BF2+) required for ion implantation than a generation of other lighter ions (BF+ and B+). Hence, since ion implantation is achieved through collision of the heavier ions with the wafer, it is possible to realize a shallow junction-depth ion implantation. Furthermore, since the plasma can be stably generated in a wider pressure range of 0.5˜100 mTorr in the first ring-shaped chamber, the plasma based ion implantation apparatus according to the present general inventive concept can stably generate plasma suitable for the plasma based ion implantation.

Generation of plasma suitable for a plasma based ion implantation process can also be more effectively achieved by injecting an inert gas (for example, Ar) for a smooth discharge in the first upper chamber 35 to generate plasma in the first upper chamber 35, while separately injecting a process gas (for example, BF3) into the second lower chamber 28.

In addition, the plasma based ion implantation apparatus 10 of the present general inventive concept can be configured to cause the RF electric field generated by the RF power from the power supply 37 to be concentrated on the first upper chamber 35, thereby making it difficult for the RF electric field to propagate to the second lower chamber 28. Hence, the ion implantation apparatus 10 according to an embodiment of the present general inventive concept is capable of reducing arcing in the second chamber 28 during the ion implantation process.

The plasma based ion implantation apparatus of the present general inventive concept can be applicable to various processes to treat surfaces of a target, such as a surface treatment of a film, an electrostatic treatment of anti-static electricity packing materials, etc., as well as, ion implantation processes of various semiconductor manufacturing processes.

A plasma based ion implantation apparatus according to another embodiment of the present general inventive concept will be described hereinafter. In the following description, the same components as those of the above embodiment will be denoted by the same reference numerals, and description thereof will be omitted.

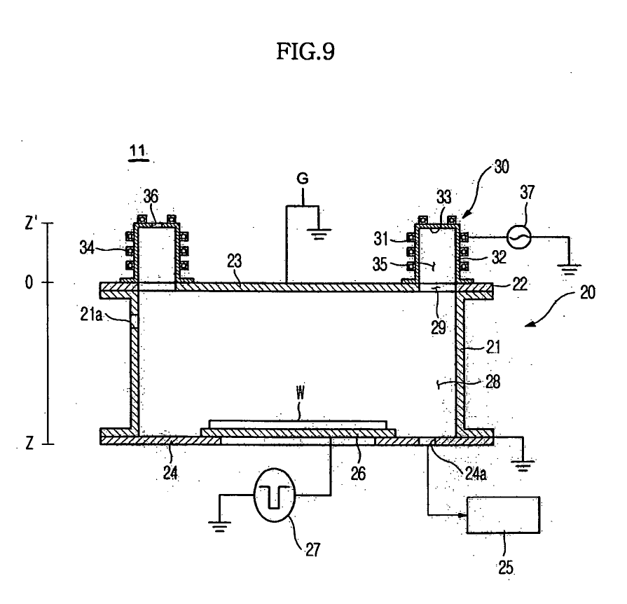

FIG. 9 is a cross-sectional view illustrating a plasma based ion implantation apparatus 11 according to another embodiment of the present general inventive concept.

Referring to FIG. 9, the plasma based ion implantation apparatus 11 may include a coil antenna 34 configured to surround an inner insulating body 31, an outer insulating body 32, and an insulating plate 33, and to apply an RF power to a first chamber 35, defined by the inner insulating body 31, the outer insulating body 32, and the insulating plate 33. The outer insulating body 32 may have the same radius as that of a main body 21. While FIG. 9 illustrates the outer insulation body 32 coupled to an upper cover 22 of the main body 21, the present general inventive concept is not limited thereto, and the outer insulating body 32 may be directly coupled to the main body 21 to omit the upper cover 22 of the main body 21 of the plasma based ion implantation apparatus 11.

As can be appreciated from the above description, according to the present general inventive concept, a plasma based ion implantation apparatus may be provided with a grounded conductor 23 facing a wafer W, thereby preventing the wafer from being contaminated by impurities due to secondary electrons and sputtering by ions of the plasma.

In addition, a plasma based ion implantation apparatus according to an embodiment of the present general inventive concept may be configured to prevent an RF electric field from propagating into a second chamber, thereby suppressing arcing in the second chamber.

Furthermore, a plasma based ion implantation apparatus according to an embodiment of the present general inventive concept may include a first ring-shaped chamber allowing a stable generation of plasma in a wider range of pressure conditions, and may be configured to allow the plasma to have a low electron temperature and a suitable plasma density while diffusing into the second chamber, thereby generating plasma suitable for an ion implantation process, and particularly for a shallow junction-depth ion implantation process.

Although a few embodiments of the present general inventive concept have been shown and described, it will be appreciated by those skilled in the art that changes may be made in these embodiments without departing from the principle and spirit of the general inventive concept, the scope of which is defined in the appended the claims and their equivalents.

What is claimed is:

1. An ion implantation apparatus, comprising:
a plasma generation unit;
an ion implantation unit to implant ions of plasma generated in the plasma generation unit into a target; and
a grounded conductor disposed in the ion implantation unit to prevent electric charging.

2. The ion implantation apparatus according to claim 1, wherein the plasma generation unit comprises:
a first chamber to define a space to generate the plasma;
a coil antenna positioned at one side of the first chamber to generate the plasma; and
a power supply to supply power to the coil antenna.

3. The ion implantation apparatus according to claim 2, wherein the ion implantation unit comprises:
a second chamber to define an ion implantation space in which the ions of the plasma generated in the plasma generation unit are implanted into the target; and,
a power source to supply a high voltage power to the target in the second chamber.

4. The ion implantation apparatus according to claim 2, wherein the power supply supplies RF power.

5. The ion implantation apparatus according to claim 3, wherein the power source applies a high voltage pulse to the target.

6. The ion implantation apparatus according to claim 3, wherein the first chamber is formed with a ring shape of a predetermined height at an upper periphery of the second chamber.

7. The ion implantation apparatus according to claim 3, wherein the second chamber has a cylindrical shape.

8. The ion implantation apparatus according to claim 3, wherein the first chamber and/or the second chamber are formed of an insulating material.

9. The ion implantation apparatus according to claim 3, wherein the second chamber is formed with an incoming port corresponding to a lower side of the first chamber to allow the plasma to be diffused from the first chamber to the second chamber.

10. The ion implantation apparatus according to claim 1, wherein the ion implantation unit comprises:
a table on which the target is mounted, and
wherein the conductor is positioned to face the table.

11. The ion implantation apparatus according to claim 1, wherein the conductor comprises Si.

12. The ion implantation apparatus according to claim 2, wherein the first chamber comprises a first gas injection port through which gas is injected thereinto.

13. The ion implantation apparatus according to claim 3, wherein the second chamber comprises a second gas injection port through which gas is injected thereinto.

14. A plasma based ion implantation apparatus, comprising:
a first chamber in which plasma is generated;
a second chamber in which ions of the plasma are implanted into a target, the second chamber having an incoming port through which the plasma is diffused from the first chamber to the second chamber;
a coil antenna to generate the plasma in the first chamber; and
a power source to supply a high voltage power to the target in the second chamber.

15. The ion implantation apparatus according to claim. 14, wherein the coil antenna is supplied with RF power.

16. The ion implantation apparatus according to claim 14, wherein the power source applies a high voltage pulse to the target.

17. The ion implantation apparatus according to claim 14, wherein the first chamber is formed with a ring shape of a predetermined height at an upper periphery of the second chamber.

18. The ion implantation apparatus according to claim 14, wherein the second chamber has a cylindrical shape.

19. The ion implantation apparatus according to claim 14, wherein the incoming port has a ring shape to open a lower side of the first chamber to the second- chamber.

20. The ion implantation apparatus according to claim 14, wherein the second chamber comprises a grounded conductor to prevent electric charging.

21. The ion implantation apparatus according to claim 20, wherein the second chamber comprises:
a table on which the target is mounted, and
wherein the conductor is positioned to face the target mounted on the table.

22. The ion implantation apparatus according to claim 20, wherein the conductor comprises Si.

23. The ion implantation apparatus according to claim 14, wherein the first chamber comprises a first gas injection port through which gas is injected thereinto.

24. The ion implantation apparatus according to claim 14, wherein the second chamber comprises a second gas injection port through which gas is injected thereinto.

25. A plasma based ion implantation apparatus, comprising:
a first chamber in which plasma is generated;
a coil antenna to generate the plasma in the first chamber;
a second chamber in which ions of the plasma are implanted into a target mounted on a table disposed inside the second chamber, the second chamber having an incoming port through which the plasma is diffused from the first chamber to the second chamber;
a power source to supply a high voltage power to the target in the second chamber; and
a grounded conductor positioned to face the target.

26. A plasma based ion implantation apparatus, comprising:
a first ring-shaped chamber in which plasma is generated;
a coil antenna to generate the plasma in the first chamber;
a second chamber in which ions of plasma diffused from the first chamber to the second chamber are implanted into a target; and
a power source to supply a high voltage power to the target in the second chamber,
wherein the first chamber is formed with a ring shape opening having a predetermined width at an upper periphery of the second chamber to communicate with the second chamber.

27. An ion implantation apparatus, comprising:
an upper chamber to generate plasma; and
a lower chamber to implant ions of the plasma generated in the upper chamber into a target,
wherein the upper chamber is disposed on an upper surface of the lower chamber and communicates with the lower chamber to allow the diffusion of the plasma to the lower chamber.

28. The apparatus of claim 27, wherein the upper chamber is configured to prevent an electric field used to generate the plasma from propagating into the lower chamber to suppress arcing in the lower chamber.

29. The apparatus of claim 27, further comprising:
an antenna coil to generate plasma in the upper chamber, disposed to surround the upper chamber; and
a conductor plate disposed inside the lower chamber and above the target to prevent the target from being contaminated.

30. The apparatus of claim 27, further comprising:
an antenna coil to generate plasma in the upper chamber, disposed at an upper surface of the upper chamber; and
a conductor plate disposed inside the lower chamber and above the target to prevent the target from being contaminated.
